(19) United States
(12) Patent Application Publication
(10) Pub. No.: US 2012/0146305 A1
(43) Pub. Date: Jun. 14, 2012

(54) Universal sway bar link

(76) Inventor: Jean-Pierre Julien, Carignan (CA)

(21) Appl. No.: 13/309,800

(22) Filed: Dec. 2, 2011

(30) Foreign Application Priority Data
Dec. 9, 2010 (GB) 1020897.3

(51) Int. Cl. B60G 21/055

(52) U.S. Cl. 280/124.106

(57) ABSTRACT

A universal sway bar link has an elongated rod member adapted to be cut to a chosen length. A first rotula member including a main portion, a first releasable attachment means adapted to releasably connect to an end of the rod member, and a first suspension attachment means adapted to be releasably connected to a first suspension member of an automobile. A second rotula member fixedly attached to a second end of the rod member opposite the end used to attach the first rotula member, and including a main portion, and a second suspension attachment means adapted to be releasably connected to a second suspension member of the automobile.

This application claims priority based on request GB1020897.3 filed Dec. 9, 2010

### FIELD OF THE INVENTION

The present invention relates generally to automotive parts but more particularly to a sway bar link being adjustable lengthwise so as to fit on most cars.

### BACKGROUND OF THE INVENTION

Link kits for sway bars are common in the auto industry and need to be replaced every couple of years, depending upon the stress endured. Since each make and model is different, a large variety of parts need to be kept in stock in order to satisfy the needs of all potential customers. Because the general configuration is the same with only the length changing, it would make sense to have a sway bar link that is adjustable length wise so as to fit on most cars.

### SUMMARY OF THE INVENTION

In view of the foregoing disadvantages inherent in the known devices now present in the prior art, the present invention, which will be described subsequently in greater detail, is to provide objects and advantages which are:

To provide for a sway bar link that is adjustable length wise so as to fit on most cars.

In order to do so, the invention comprises an elongated rod member adapted to be cut to a chosen length. A first rotula member including a main portion, a first releasable attachment means adapted to releasably connect to an end of the rod member, and a first suspension attachment means adapted to be releasably connected to a first suspension member of an automobile. A second rotula member fixedly attached to a second end of the rod member opposite the end used to attach the first rotula member, and including a main portion, and a second suspension attachment means adapted to be releasably connected to a second suspension member of the automobile.

The first releasable attachment means includes a nipple member extending outwardly from the main portion of the first rotula member, wherein the nipple member is internally threaded; and wherein the rod member is externally threaded, such that the nipple member is adapted to be screwed onto the end of the rod member after the rod member is cut to the desired length.

A lock nut is used to lock the nipple member in place upon the threaded rod member.

The first suspension attachment means includes an elongated cylindrical threaded bolt extending from the main portion of the first rotula member and extends perpendicularly to the direction of the nipple member; and a first lock nut adapted to removably secure the first rotula member to the first suspension member of the automobile.

The second suspension attachment means includes an elongated cylindrical threaded bolt extending from the main portion of the second rotula and extending perpendicular to the direction of the rod member, and a second lock nut adapted to removably secure the second rotula member to the second suspension member of the car.

The invention has a method of changing a sway bar link of an automobile using a universal sway bar link, comprising the steps of:
a. Providing a rod member adapted to be cut to a chosen length.
b. Providing a first rotula member including a main portion, a first releasable attachment means adapted to releasably connect to an end of said rod member, and a first suspension attachment means adapted to be releasably connected to a first suspension member of an automobile.
c. Providing a second rotula member fixedly attached to a second end of said rod member opposite the end used to attach said first rotula member, and including a main portion, and a second suspension attachment means adapted to be releasably connected to a second suspension member of said automobile.
d. Removing an existing sway bar link from an automobile; measuring said sway bar to determine the length of said rod member.
e. Cutting said rod member to the determined length.
f. Attaching said first rotula member to said first suspension member of said automobile.
g. Attaching said rod member to said first rotula member.
h. Attaching said second suspension attachment means to said second suspension member of said automobile.

There has thus been outlined, rather broadly, the more important features of the invention in order that the detailed description thereof that follows may be better understood, and in order that the present contribution to the art may be better appreciated. There are additional features of the invention that will be described hereinafter and which will form the subject matter of the claims appended hereto.

In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of description and should not be regarded as limiting.

As such, those skilled in the art will appreciate that the conception, upon which this disclosure is based, may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

Further, the purpose of the foregoing abstract is to enable the U.S. Patent and Trademark Office and the public generally, and especially the scientists, engineers and practitioners in the art who are not familiar with patent or legal terms or phraseology, to determine quickly from a cursory inspection the nature and essence of the technical disclosure of the application. The abstract is neither intended to define the invention of the application, which is measured by the claims, nor is it intended to be limiting as to the scope of the invention in any way.

These together with other objects of the invention, along with the various features of novelty which characterize the invention, are pointed out with particularity in the claims annexed to and forming a part of this disclosure. For a better understanding of the invention, its operating advantages and the specific objects attained by its uses, reference should be made to the accompanying drawings and descriptive matter which contains illustrated preferred embodiments of the invention.

### BRIEF DESCRIPTION OF THE DRAWINGS

FIGS. 1a-b Exploded view and isometric view of the invention, respectively.

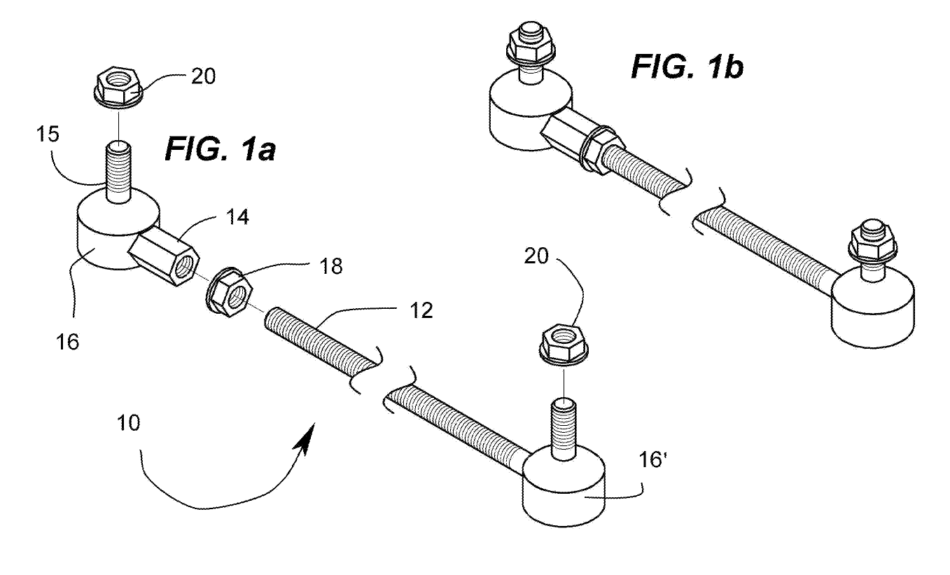

FIGS. 2a-b Exploded view and isometric view of a variant the invention, respectively.

FIGS. 3a-c Top side and front views, respectively, of the invention.

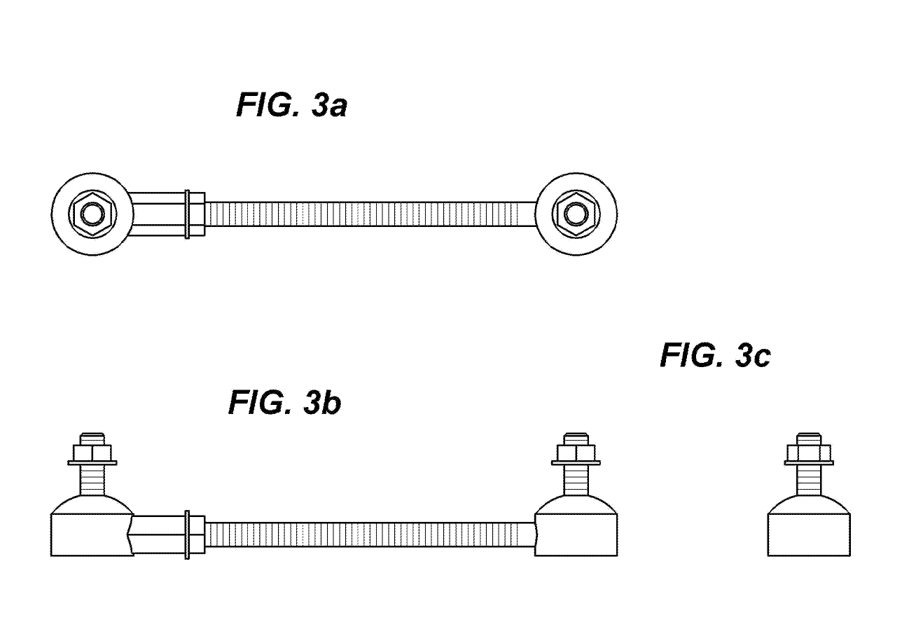

FIG. 4 Isometric view of the invention in context.

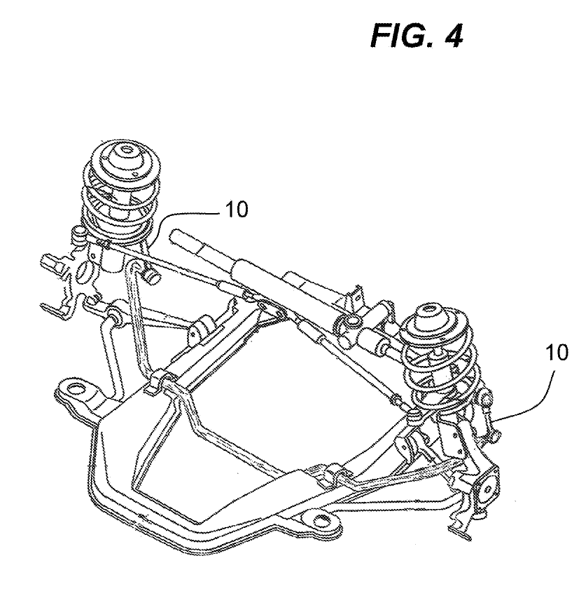

### DETAILED DESCRIPTION OF THE PREFERRED EMBODIMENT

A universal sway bar link (10) is comprised an elongated rod member (12) which can be cut to a given length, if necessary. Final length adjustment of the rod member (12) is done by screwing a nipple (14) over the rod member (12) which extends integrally from a first rotula member (16). Once adjusted to length, the nipple (14) is locked in place by a lock nut (18).

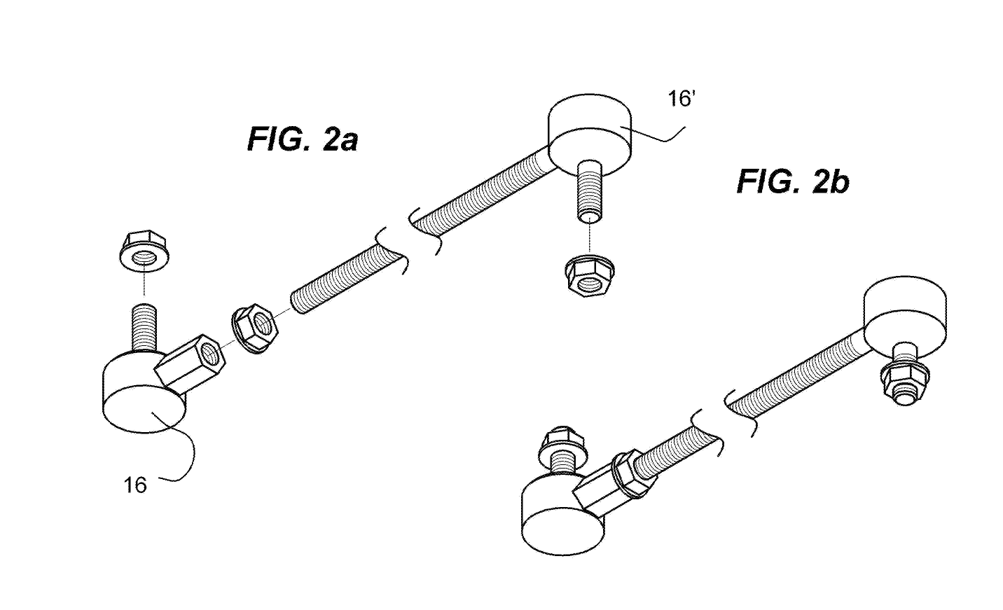

Attachment nuts (20) attach the universal sway bar link (10) by way of an elongated cylindrical threaded bolt (15) to the rest of the suspension system, as is known in the art. A second rotula member (16′) can have different orientations, as seen in FIGS. 2a-b, according to the make and model of the car. That orientation is also locked in place by the lock nut (18) during the process of adjusting the length and installing the sway bar (10).

An installer, after having removed an old sway bar link (not shown), will roughly measure it so as to have an idea of how much of the rod member (12) needs to be cut. Then, the first rotula member (16) is installed on a suspension member (24) and attached by way of the attachment nut (20). Then, the rod member (12) is screwed into the nipple (14) until the second rotula member (16′) is aligned with its corresponding attachment point (not shown) on a car (22). Once attached by way of the attachment nut (20), the lock nut (18) is tightened against the nipple (14) to securedly lock the overall length and orientation of the sway bar (10).

As to a further discussion of the manner of usage and operation of the present invention, the same should be apparent from the above description. Accordingly, no further discussion relating to the manner of usage and operation will be provided. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention. Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

1. A universal sway bar link for automobiles comprising an elongated rod member adapted to be cut to a chosen length; a first rotula member including a main portion, a first releasable attachment means adapted to releasably connect to an end of said rod member, and a first suspension attachment means adapted to be releasably connected to a first suspension member of an automobile; a second rotula member fixedly attached to a second end of said rod member opposite the end used to attach said first rotula member, and including a main portion, and a second suspension attachment means adapted to be releasably connected to a second suspension member of said automobile.

2. The universal sway bar link of claim 1, wherein said first releasable attachment means includes a nipple member extending outwardly from said main portion of said first rotula member, wherein said nipple member is internally threaded; and wherein said rod member is externally threaded, such that said nipple member is adapted to be screwed onto the end of said rod member after said rod member is cut to the desired length.

3. The universal sway bar link of claim 2, wherein a lock nut is used to lock said nipple member in place upon said threaded rod member.

4. The universal sway bar link of claim 1, wherein said first suspension attachment means includes an elongated cylindrical threaded bolt extending from said main portion of said first rotula member and extends perpendicularly to the direction of said nipple member; and a first lock nut adapted to removably secure said first rotula member to said first suspension member of said automobile.

5. The universal sway bar link of claim 1, wherein said second suspension attachment means includes an elongated cylindrical threaded bolt extending from said main portion of said second rotula and extending perpendicular to the direction of said rod member, and a second lock nut adapted to removably secure said second rotula member to said second suspension member of said car.

6. A combination of an automobile and a universal sway bar link, said combination comprising an automobile; and a universal sway bar link comprising an elongated rod member adapted to be cut to a chosen length; a first rotula member including a main portion, a first releasable attachment means adapted to releasably connect to an end of said rod member, and a first suspension attachment means adapted to be releasably connected to a first suspension member of an automobile; a second rotula member fixedly attached to a second end of said rod member opposite the end used to attach said first rotula member, and including a main portion, and a second suspension attachment means adapted to be releasably connected to a second suspension member of said automobile.

7. The universal sway bar link of claim 6, wherein said first releasable attachment means includes a nipple member extending outwardly from said main portion of said first rotula member, wherein said nipple member is internally threaded; and wherein said rod member is externally threaded, such that said nipple member is adapted to be screwed onto the end of said rod member after said rod member is cut to the desired length.

8. The universal sway bar link of claim 7, wherein a lock nut is used to lock said nipple member in place upon said threaded rod member.

9. The universal sway bar link of claim 6, wherein said first suspension attachment means includes an elongated cylindrical threaded bolt extending from said main portion of said first rotula member and extends perpendicularly to the direction of said nipple member; and a first lock nut adapted to removably secure said first rotula member to said first suspension member of said automobile.

10. The universal sway bar link of claim 6, wherein said second suspension attachment means includes an elongated cylindrical threaded bolt extending from said main portion of said second rotula and extending perpendicular to the direction of said rod member, and a second lock nut adapted to removably secure said second rotula member to said second suspension member of said car.

11. A method of changing a sway bar link of an automobile using a universal sway bar link, said method comprising the steps of:
a. providing a rod member adapted to be cut to a chosen length;
b. providing a first rotula member including a main portion, a first releasable attachment means adapted to releasably connect to an end of said rod member, and a first suspension attachment means adapted to be releasably connected to a first suspension member of an automobile;
c. providing a second rotula member fixedly attached to a second end of said rod member opposite the end used to attach said first rotula member, and including a main portion, and a second suspension attachment means adapted to be releasably connected to a second suspension member of said automobile;
d. removing an existing sway bar link from an automobile; measuring said sway bar link to determine the length of said rod member;
e. cutting said rod member to the determined length;
f. attaching said first rotula member to said first suspension member of said automobile;
g. attaching said rod member to said first rotula member; and
h. attaching said second suspension attachment means to said second suspension member of said automobile.

12. The universal sway bar link of claim 11, wherein said first releasable attachment means includes a nipple member extending outwardly from said main portion of said first rotula member, wherein said nipple member is internally threaded; and wherein said rod member is externally threaded, such that said nipple member is adapted to be screwed onto the end of said rod member after said rod member is cut to the desired length.

13. The universal sway bar link of claim 12, wherein a lock nut is used to lock said nipple member in place upon said threaded rod member.

14. The universal sway bar link of claim 11, wherein said first suspension attachment means includes an elongated cylindrical threaded bolt extending from said main portion of said first rotula member and extends perpendicularly to the direction of said nipple member; and a first lock nut adapted to removably secure said first rotula member to said first suspension member of said automobile.

15. The universal sway bar link of claim 11, wherein said second suspension attachment means includes an elongated cylindrical threaded bolt extending from said main portion of said second rotula and extending perpendicular to the direction of said rod member, and a second lock nut adapted to removably secure said second rotula member to said second suspension member of said car.
